(19) United States
(12) Patent Application Publication
(10) Pub. No.: US 2002/0162510 A1
(43) Pub. Date: Nov. 7, 2002

(54) Animal nourishment delivery gate

(75) Inventors: Thomas Hogan, Marietta, GA (US); Kimberly Quinn, Kenansville, NC (US)

Correspondence Address: William Brook Lafferty, Troutman Sanders LLP, 600 Peachtree Street, N.E. Suite 5200, Atlanta, GA, 30308-2216, US

(73) Assignee: VAC-PAC, Inc.

(21) Appl. No.: 09/848,393

(22) Filed: May 3, 2001

(51) Int. Cl. A01K 61/02

(52) U.S. Cl. 119/52.1

(57) ABSTRACT

An animal gate has an integrally formed water delivery tube to deliver low-pressure water to a water trough and an integrally formed food supply bin to deliver animal food to a food trough. Both water and food supplies in the respective troughs are maintained by static force. In an optional embodiment, the water supply can be shut off via valve, and the water trough can be purged via a sealable drain in the bottom of the water trough.

### BACKGROUND

Many animals, including hogs, are maintained in individual pens during substantial portions of their adult lives. Female hogs, known as sows, are typically housed in specially designed pens that allow them to lay down and nurse their young without injuring their young. Sows are also fed and watered in these pens. Normally, food is provided by a farmer on at least a daily basis, and water is supplied through an automatic delivery system.

Because sanitary conditions in sow pens or sow “crates” as they are called are poor, large amounts of food placed in a sow crate are subject to being contaminated with hog waste. Similarly, the large amounts of water—such as the 50-60 gallons of water consumed by a single sow in a single day—cannot be placed in the sow crate, either. In recent years, the preferred method for delivering water to sows requires a high-pressure pump to deliver pressurized water through a high-pressure hose to a squeeze nipple in the sow crate. When the sow is thirsty, she bites the nipple and pressurized water is squirted into her mouth through a small opening in the nipple. When all aspects of the system are functioning properly, this arrangement delivers an adequate water supply.

It is often the case, however, that conditions inside the sow crate result in blockage of the nipple. In many cases, particles of food, dirt or an accumulation of slobber diminish the functionality of the nipple and prevent the sow from getting a sufficient amount of water. When a sow fails to get a sufficient amount of water, the sow's ability to properly nurse her young is affected, along with her general health. Even worse, it is very difficult for a farmer to determine, without checking, whether a sow's watering system is functioning properly. Because many farmers have hundreds of sows each in different sow crates, individual crates are seldom inspected for this problem.

The current system also poses other limitations. High-pressure water pumps are needed to maintain adequate water pressure through the network of hoses and nipples going from the water supply to each sow crate. These pumps, as mechanical instruments, have limited life expectancies and must be replaced, at a cost of time, money, and disruption in operation. Furthermore, the high pressure hoses necessary for delivery of pressurized water to the sow crates are susceptible to developing leaks, forcing loss of water, loss of pressure and another disruption every time a leak develops.

Finally, sow crates (including the gate portions) are currently made of stainless steel. This otherwise hearty material decays quickly in an environment where it is constantly exposed to the highly corrosive effects of hog waste, including large amounts of methane gas and other waste by-products. These gates are expensive to replace and, because the high pressure water lines typically attached to the stainless steel gates do not fare well when disconnected from an old gate and reconnected to a replacement gate, the relative frailty of the stainless steel gates further complicates difficulties with high-pressure water delivery systems.

Accordingly, there is a need for a system for delivery of water to animals in holding crates that will have improved reliability and delivery characteristics over current systems.

There is another need for a system for delivering food to animals such as hogs that will allow delivery of a large amount of food without allowing the food to become spoiled by waste in the feeding area.

Finally, there is a need for a gate for a sow crate that will accomplish the above-stated needs while demonstrating improved resiliency to corrosive agents in the sow crate.

### BRIEF SUMMARY OF THE INVENTION

These and other shortcomings relating to animal crate gates and nourishment delivery systems are solved by the present invention. More specifically, the present invention is an animal nourishment delivery gate that has an integrally formed water delivery tube, connected to a low-pressure water supply by a joint, for static delivery of low-pressure water to a water trough. The present invention also includes an integrally formed food supply bin having a food trough for delivery of animal food to an animal. In a preferred embodiment of the present invention, the animal nourishment delivery gate is constructed of a corrosion-resistant member of the plastics family, and further includes a shut-off valve to stop the delivery of water to the water trough so that the water trough can be cleaned and purged by through a water trough drain.

### BRIEF DESCRIPTION OF THE DRAWINGS

FIG. 1 is a perspective view of an exemplary embodiment of the present invention.

FIG. 2 depicts a front view of another exemplary embodiment of the present invention.

FIG. 3 is a side view of the exemplary embodiment depicted in FIG. 2.

### DETAILED DESCRIPTION OF EXEMPLARY EMBODIMENTS

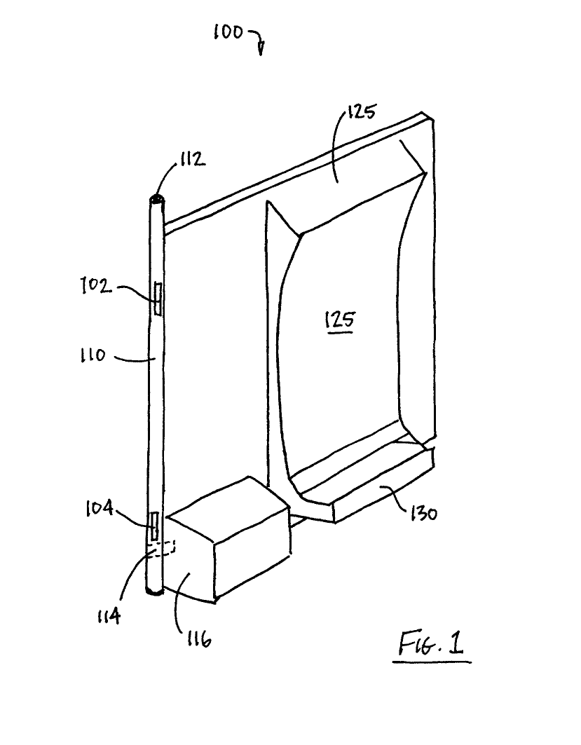

FIG. 1 depicts a perspective view of an embodiment of the present invention. Gate 100 is preferably manufactured as one single piece. Ideally, because of the caustic corrosive agents present in the intended environment of a hog farm, the gate 100 is formed of a corrosion-resistant material such as polyvinyl chloride (PVC) or another such plastic derivative having qualities of durability and relatively light weight. The gate 110 is attached to a surrounding, stationary cage portion (not shown) by hinges 102 and 104, and the gate is secured in a closed position, when desired, by latch 106 or, in an optional embodiment, a double latch.

The gate 100 is formed so as to define an integral water delivery tube 100, the water delivery tube 110 having a first tube end 112 and a second tube end 114. The first tube end 112 is generally referred to as the supply side tube end because it is the end of the water delivery tube 110 that is connected to a water supply hose or conduit. The second tube end 114 is generally referred to as the consumption side tube end because it is the end of the water delivery tube 110 that supplies water to the animal. The consumption side tube end 114 terminates into the water trough 116, the water trough 116 also being integrally formed into the gate 100 by manufacturing methods well known to those skilled in the art of plastics fabrication. In an alternate embodiment, the water trough 116 may not be integrally formed with the gate 100, but is integrally attached thereto in a secure fashion.

Importantly, the positioning of the consumption side tube end 114 relative to the water trough 116 is notable. In a preferred embodiment, the consumption side tube end 114 is positioned near the top of the water trough 116. By positioning in this manner, sediment such as dirt, food, excrement, etc. that may be introduced into the water contained in the water trough 116 will sift to the bottom of the water trough 116 and will not interfere substantially with the further delivery of water to the water trough 116 by the water delivery tube 110.

Water is delivered to the water trough 116 via the water delivery tube 110 in a low-pressure arrangement. Because the water delivery is low pressure, water can remain standing in the water trough 116 because of the static resistance of the volume of water in the water opposing the volume of water coming from the water source.

The food supply bin 120 is also integrally formed with the gate 100 in a preferred embodiment of the present invention, although alternate embodiments may find the food supply bin 120 integrally attached to the gate 100 in a secure manner. The food supply bin 120 is sized and designed to store a quantity of food for the animal. Thus, the food supply bin 120 is accessible to a farmer via the opening 125. The opening 125 is preferably wide enough to allow the farmer to deposit food therein without unnecessary spillage.

As the food supply bin 120 is filled with food, the food falls into the food trough 130 below. Once the food trough is filled, or substantially filled, the static force of the food in the food trough will prevent the food remaining in the food supply bin 120 from spilling out. As the animal eats food from the food trough 130, the force of the food in the food supply bin 120 will urge another amount of food—generally equivalent to the amount of food consumed—into the food trough 130, keeping the food trough 130 filled with food for as long as food remains in the food supply bin 120. The dimensions of the food supply bin 120 depicted in herein are representative only—these dimensions can be varied to accommodate different animal types, different food types, and different feeding regimens.

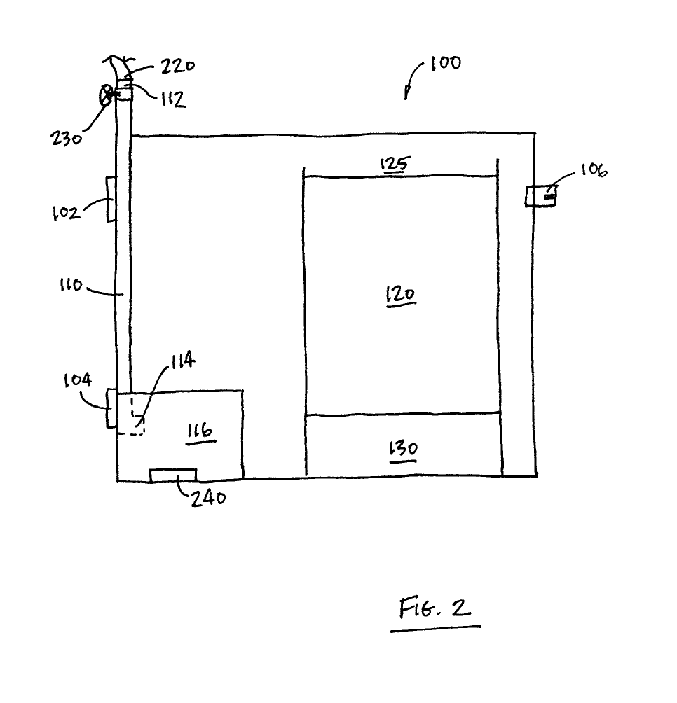

FIG. 2 is a front view of another preferred embodiment of the present invention. Gate 100 having hinges 102, 104 and latch 106 also has a water delivery tube 110 having supply tube end 112 and a consumption tube end 114. The consumption tube end empties into the water trough 116. At the supply tube end 112, a joint 210 connects the supply tube end 112 to a supply hose 220. The embodiment depicted in FIG. 2 incorporates a shut-off valve 230 into the water delivery tube 110 to terminate the supply of water from the water supply to the water trough. One reason for utilizing the shut-off valve 230 in this way is to clean the water trough 116. Once the shut-off valve 230 is turned in the closed position, a water trough drain 240 may be opened, thereby releasing the remaining water in the water delivery tube 110 and the water trough 116, effectively cleaning any accumulated sediment from the bottom of the water trough 116.

FIG. 2 also depicts the food supply bin 120 and its opening 125 for receiving food and its food trough 130 for making the food available to an animal for consumption.

FIG. 3 is a side view of the gate 110, as viewed from the side of the hinges 102, 104. The supply hose 220 connects to the joint 210. When the shut-off valve 230 is in the open position, water flows from the supply hose 220 through the shut-off valve 230 and through the water delivery tube 110 of the frame and into the water trough 116.

Food is deposited into the opening 125 of the food supply bin 120. The food falls through the food supply bin 120 until it reaches the food trough 130, where it stays—preventing further food flow—until the animal eats the food, at which time the food in the food trough 130 is replenished by food in the food supply bin 120.

These embodiments are not intended to limit the scope of the invention—rather, the scope of the invention should only be limited by the claims below.

I claim:

1. An animal nourishment delivery gate, comprising:
a gate having an integrally formed water delivery tube for static delivery of low-pressure water into an integrally formed water trough;
a joint, functional to connect the water delivery tube to a low-pressure water source; and
an integrally formed food supply bin having a food trough for delivery of animal food to an animal from the food supply bin.

2. The animal nourishment delivery gate of claim 1, wherein the integrally formed water delivery tube includes a manual shut-off valve.

3. The animal nourishment delivery gate of claim 2, wherein the integrally formed water trough incorporates a sealable drain to permit removal of foreign objects from the water trough.
